(19) United States
(12) Patent Application Publication
(10) Pub. No.: US 2020/0301824 A1
(43) Pub. Date: Sep. 24, 2020

(54) DATA CREATION APPARATUS, TESTING SYSTEM, DATA CREATION METHOD, AND PROGRAM

(71) Applicant: NEC CORPORATION, Tokyo (JP)

(72) Inventors: Hiroki OYAMA, Tokyo (JP); Koichi AKIBA, Tokyo (JP); Masahiko YONEMOCHI, Tokyo (JP); Takeshi SUZUKI, Tokyo (JP)

(73) Assignee: NEC CORPORATION, Tokyo (JP)

(21) Appl. No.: 16/762,409

(22) PCT Filed: Nov. 7, 2018
(86) PCT No.: PCT/JP2018/041326

§ 371 Date: May 7, 2020

(30) Foreign Application Priority Data
Nov. 8, 2017 (JP) 2017-215746

(51) Int. Cl. G06F 11/36; G06N 5/02

(52) U.S. Cl. CPC G06F 11/3692; G06F 11/3676; G06N 5/025; G06F 11/3688; G06F 11/3684

(57) ABSTRACT

A data creation apparatus is provided with a storage part that stores one or more first rules as a template, a data collection part that obtains signal data from a target communication environment, a data analysis part that uses the template to determine a processing method for the signal data, and a data processing part that processes the signal data based on the processing method, to create processed data.

### CROSS REFERENCE TO RELATED APPLICATIONS

This application is a National Stage of International Application No. PCT/JP2018/041326, filed Nov. 7, 2018, claiming priority to Japanese Patent Application No. 2017-215746, filed Nov. 8, 2017, the contents of all of which are incorporated herein by reference in their entirety.

### FIELD

The present invention relates to a data creation apparatus, a testing system, a data creation method, and a program.

### BACKGROUND

A tester or an apparatus to perform testing has to create test data when testing a communication system. For example, the tester may manually create a signal and information based on a software specification or design document. Specifically, the tester may manually create a signal or parameter related to a conditional branch or available range for a variable (for example, maximum value, minimum value or the like), based on the software specification or design document.

Patent Literature 1 describes technology for extracting a signal satisfying a prescribed protocol type for an application layer, a prescribed transmission/reception source address of a packet, or a prescribed destination address of a packet, from signal(s) transmitted or received by communication equipment in operation.

Patent Literature 2 describes technology to determine whether or not data transmitted by a client terminal is data in a normal state, and to create data in a normal state as test data.

### [PTL 1]

Japanese Patent Kokai Publication No. JP2006-352290A

### [PTL 2]

Japanese Patent Kokai Publication No. JP2009-026020A

### SUMMARY

It is to be noted that the disclosure of the abovementioned cited literature is incorporated herein by reference thereto. The following analysis is given from a viewpoint of the present invention.

When testing a communication system, with regard to information for defining a signal, a tester may create test data using representative information. In such a case, the tester may omit ancillary information (below, also called optional information) in creating the test data.

The tester uses the representative information to create test data omitting optional information, and tests the communication system. In a case where the communication system is tested using this type of test data, in actuality there is a risk of an operational problem occurring in that when the communication system is operated, an untested signal (an unforeseen signal) is received.

Therefore, it is desirable that the tester uses test data that conforms with an actual operation environment, to test the communication system. However, the more the information for testing increases, the more human resources (time, skill) increase.

In the technology described in Patent Literature 1, an extracted signal may include data not intended by the tester. Therefore, in a case of using the technology described in Patent Literature 1 to carry out a test, a test different from the tester's intention may be implemented.

In the technology described in Patent Literature 2, data in a normal state transmitted by a client terminal is created as test data. Therefore, in the technology described in Patent Literature 2, the created test data may include data not intended by the tester. Therefore, in a case of using the test data described in Patent Literature 2 to carry out a test, a test different from the tester's intention may be implemented.

Therefore, it is an object of the present invention to provide a data creation apparatus, a testing system, a data creation method, and a program, which contribute to facilitating creation of data corresponding to a user's intention from a signal flowing in an arbitrary communication environment.

According to a first aspect a data creation apparatus is provided. The data creation apparatus is provided with a storage part that stores one or more first rules as a template. The data creation apparatus is further provided with a data collection part that obtains signal data from a target communication environment. The data creation apparatus is further provided with a data analysis part that uses the template to determine a processing method for the signal data. The data creation apparatus is further provided with a data processing part that processes the signal data based on the processing method, to create processed data.

According to a second aspect a testing system is provided. The testing system is configured to include a target communication environment that includes a target apparatus that outputs signal data, and a data creation apparatus that is connected to the target communication environment. The data creation apparatus is provided with a storage part that stores one or more first rules as a template. The data creation apparatus is further provided with a data collection part that obtains the signal data from the target communication environment. The data creation apparatus is further provided with a data analysis part that uses the template to determine a processing method for the signal data. The data creation apparatus is further provided with a data processing part that processes the signal data based on the processing method, to create processed data.

According to a third aspect a data creation method is provided. The data creation method includes storing one or more first rules as a template. The data creation method further includes obtaining signal data from a target communication environment. The data creation method further includes using the template to determine a processing method for the signal data. The data creation method further includes processing the signal data based on the processing method, to create processed data. It is to be noted that the method is associated with a particular mechanism, known as a data creation apparatus that obtains signal data from the target communication environment.

According to a fourth aspect a program is provided. The program causes a computer to execute processing to control a data creation apparatus to store one or more first rules as a template. The program further causes the computer to execute processing to obtain signal data from a target communication environment. The program further causes the computer to execute processing to determine a processing method for the signal data, using the template. The program further causes the computer to execute processing to process the signal data based on the processing method, to create processed data. It is to be noted that this program may be recorded on a computer-readable storage medium. The storage medium may be a non-transient medium such as semiconductor memory, a hard disk, a magnetic recording medium, an optical recording medium or the like. The present invention may be embodied as a computer program product.

According to the respective aspects, the invention provides a data creation apparatus, a testing system, a data creation method, and a program, which contribute to facilitating creation of data corresponding to a user's intention, from a signal flowing in any communication environment.

### BRIEF DESCRIPTION OF THE DRAWINGS

FIG. 1 is a diagram illustrating an outline of an example embodiment.

FIG. 2 is a block diagram showing an example of an internal configuration of a data creation apparatus 100 according to a first example embodiment.

FIGS. 3A and 3B are diagrams showing an example of a sequence pattern template 111.

FIG. 4 is a flowchart showing an example of operations of the data creation apparatus 100 according to the first example embodiment.

FIG. 5 is a flowchart showing an example of operations of the data creation apparatus 100 according to the first example embodiment.

FIG. 6 is a diagram showing an example of a textualized signal sequence.

FIG. 7 is a diagram showing an example of a textualized signal sequence.

### PREFERRED MODES

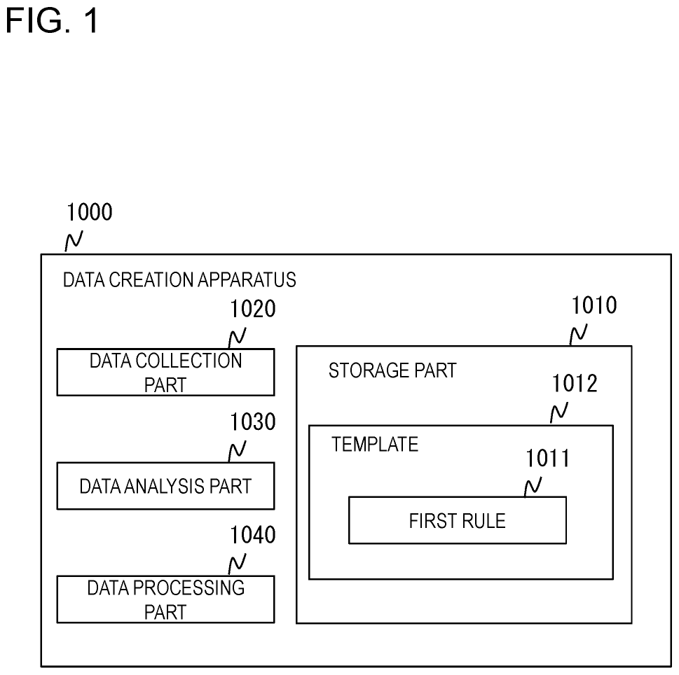

First, a description is given concerning an outline of an example embodiment using FIG. 1. It is to be noted that reference symbols in the drawings attached to this outline are added to respective elements for convenience, as examples to aid understanding, and there is no intention to limit the invention in any way. Connection lines between blocks in respective block diagrams may be bidirectional or unidirectional. Unidirectional arrows schematically show flow of main signals (data), but do not exclude bidirectionality. In addition, although not explicitly disclosed, an input port and output port are respectively present at an input terminal and output terminal of each connection line, in connection parts for respective connection lines of respective blocks. The same applies for input output interfaces.

As described above, a data creation apparatus is desired that contributes to facilitating creating data corresponding with a user's intent, from a signal flowing in an arbitrary communication environment.

Thus, as one example, the data creation apparatus 1000 shown in FIG. 1 is provided. The data creation apparatus 1000 is provided with a storage part 1010, a data collection part 1020, a data analysis part 1030, and a data processing part 1040.

The storage part 1010 stores one or more first rules 1011 as a template 1012. The data collection part 1020 obtains signal data from a target communication environment. The data analysis part 1030 uses the template 1012 to determine a processing method for the signal data obtained by the data collection part 1020. The data processing part 1040 processes the signal data based on the processing method determined by the data analysis part 1030 to create processed data.

For example, the data creation apparatus 1000 holds in advance an arbitrary rule (that is, a first rule 1011) created by the tester, as a template 1012. In the communication system, the data creation apparatus 1000 further obtains signal data from an actual operation environment (that is, the target communication environment). In this case, in the communication system, the data creation apparatus 1000 processes signal data flowing in the actual operation environment based on an arbitrary rule determined by the user. As a result, the data creation apparatus 1000 can create test data corresponding to the tester's intention, being test data in conformance with the actual operation environment.

Therefore, the data creation apparatus 1000 contributes to facilitating the creation of data corresponding to a user's intent from a signal flowing in an arbitrary communication environment.

### First Exemplary Embodiment

A more detailed description is given concerning a first example embodiment, using the drawings. It is to be noted that in the following description the abovementioned template is called a sequence pattern template.

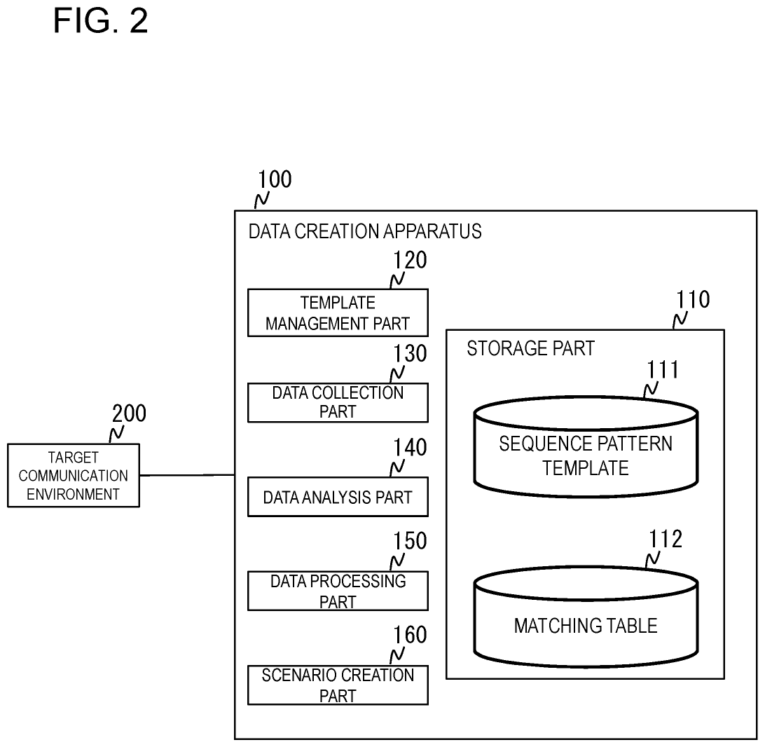

FIG. 2 is a block diagram showing an example of an internal configuration of a data creation apparatus 100 according to the present example embodiment. The data creation apparatus 100 is configured to include a storage part 110, a template management part 120, a data collection part 130, a data analysis part 140, a data processing part 150, and a scenario creation part 160. It is to be noted that FIG. 2 mainly illustrates a module related to the data creation apparatus 100 according to the present example embodiment. The data creation apparatus 100 clearly may also be configured to include hardware and software that are not illustrated.

The data creation apparatus 100 is an information processing apparatus (computer) that creates data corresponding to a target apparatus or system. The data creation apparatus 100 is configured to include a CPU (Central Processing Unit), a memory, an NIC (Network Interface Card), and the like.

It is to be noted that in the following description, the data creation apparatus 100 is described by illustrating as an example a case of using the abovementioned processed data as data for use in testing. In the following description, the data processed by the data creation apparatus 100 is called test data. However there is no intention to limit the data creation apparatus 100 according to the present example embodiment to creating data for use in testing. The data created by the data creation apparatus 100 clearly may be used as appropriate, in accordance with purpose, environment or the like.

The data creation apparatus 100 is connected with a target communication environment 200. The target communication environment includes an apparatus that outputs signal data. For example, the target communication environment 200 may be a communication system applied to business. In the target communication environment 200 a signal may be generated that is not intended by the providing side of an apparatus to be tested and/or a system to be tested.

The storage part 110 stores one or more first rules as a sequence pattern template 111. The storage part 110 further stores a matching table 112 (second rule). It is to be noted that the storage part 110 clearly may store various types of data described in the present document. The storage part 110 is realized by a magnetic disk apparatus, optical disk apparatus, semiconductor memory, or the like.

The sequence pattern template 111 is information for specifying a signal sequence that is to be extracted. The sequence pattern template 111 may include information related to a condition for specifying the signal sequence. This may include a regular expression, an OR condition, or the like. In the following description, a condition for specifying a signal sequence is also called an extraction condition. Details of the sequence pattern template 111 are described later.

The matching table 112 is configured to include a second rule different from the first rule. Specifically, the matching table 112 is configured to include information specifying service type corresponding to test data, as the second rule.

The template management part 120 obtains one or more of the first rules, and stores the obtained first rule(s) as a sequence pattern template 111 in the storage part 110.

For example, the template management part 120 may obtain the first rule, based on a user operation. For example, the template management part 120 may obtain a file describing the first rule(s) and store the file in the storage part 110 as the sequence pattern template 111. It is to be noted that this is an example of a means of obtaining the sequence pattern template 111, and there is no intention to limit the method of obtaining the sequence pattern template 111.

Similarly, the template management part 120 obtains one or more of the second rule(s), and stores the obtained second rule(s) as a matching table 112 in the storage part 110.

For example, the template management part 120 may obtain the second rule(s), based on a user operation. For example, the template management part 120 may obtain a file describing the second rule(s) and store the file in the storage part 110 as the matching table 112. It is to be noted that this is an example of a means of obtaining the matching table 112, and there is no intention to limit the method of obtaining the matching table 112.

The data collection part 130 obtains signal data that includes a signal sequence related to a communication session, and management information specifying communication content, from the target communication environment 200. For example, the data collection part 130 obtains packet data flowing in the target communication environment 200, as signal data.

For example, the data collection part 130 may obtain signal data that includes a signal sequence related to a communication session, and management information specifying communication content, based on a prescribed condition, from the target communication environment 200. For example, the data collection part 130 may obtain a signal sequence related to a communication session, and management information specifying communication content, based on a prescribed condition, at prescribed time intervals, from the target communication environment 200. A method by which the data collection 130 obtains the signal data and the management information from the target communication environment 200 is not limited to the above, and by using a suitable method as appropriate, the signal data and the management information are obtained from the target communication environment 200.

Here, a communication protocol for the signal sequence may be SIP (Session Initiation Protocol), SIP-T (SIP for Telephones), ISUP (ISDN (Integrated Services Digital Network) User Part), INAP (Intelligent Network Application Protocol) or the like. It is to be noted that these are merely examples of a communication protocol for the signal sequence and there is no intention to limit the communication protocol for the signal sequence, in the data creation apparatus 100 according to the present example embodiment.

The management information specifying communication content may include service type, billing data or the like. For example, the data collection part 130 may obtain a CDR (Call Data Record) binary from the target communication environment 200, as management information specifying the communication content. It is to be noted that the description below exemplifies a case where the data collection part 130 obtains the CDR binary from the target communication environment 200, as management information specifying the communication content. That is, the data collection part 130 obtains the signal data and CDR binary from the target communication environment 200. However there is no intended limitation to the data collection part 130 according to the present example embodiment obtaining the CDR binary.

The data analysis part 140 uses the sequence pattern template 111 to determine a processing method for the signal data obtained by the data collection part 130. Specifically, the data analysis part 140 uses the sequence pattern template 111 or the like to analyze the signal data obtained by the data collection part 130. The data analysis part 140 determines a method of processing the signal data (method of editing signal data).

More specifically, the data analysis part 140 extracts a signal sequence that satisfies an extraction condition, from the signal data obtained by the data collection part 130. The data analysis part 140 analyzes the extracted signal sequence. The data analysis part 140 determines a method of processing the extracted signal data based on an analysis result.

Below a further detailed description is given concerning the data analysis part 140. It is to be noted that in the following description, the sequence pattern template 111 indicates a sequence pattern template 111 which the data analysis part 140 has selected.

The data analysis part 140 refers to the storage part 110 and selects the sequence pattern template 111 to be used. The data analysis part 140 extracts a signal sequence that satisfies a first rule in the selected sequence pattern template 111, from the signal data. The data analysis part 140 creates a first data pattern (below, referred to as test data pattern), based on the extracted signal sequence. The data analysis part 140 uses the test data pattern to determine the method of processing the signal data. The data analysis part 140 discards a signal sequence that does not satisfy the first rule, from the signal data.

More specifically, the data analysis part 140 extracts a signal sequence that satisfies the first rule, from the signal data. The data analysis part 140 extracts a third data pattern (below, referred to as signal information pattern), from the extracted signal sequence. The data analysis part 140 uses the extracted signal information pattern to create a test data pattern.

Specifically, the data analysis part 140 creates a fourth data pattern related to type of communication session (below, referred to as management information pattern), based on management information included in the signal data. The data analysis part 140 creates a test data pattern, based on signal sequence, signal information pattern and management information pattern, satisfying a first rule in the selected sequence pattern template 111.

Next, the data analysis part 140 applies the matching table 112 to the test data pattern and creates a second data pattern (below, referred to as derived template pattern).

For example, the matching table 112 is configured to include the CDR corresponding to the test data as a second rule. In this case, the data analysis part 140 may determine a different derived template pattern in accordance with the CDR, even with an identical signal sequence. Therefore, the data analysis part 140 may create a different derived template pattern, even with an identical signal sequence.

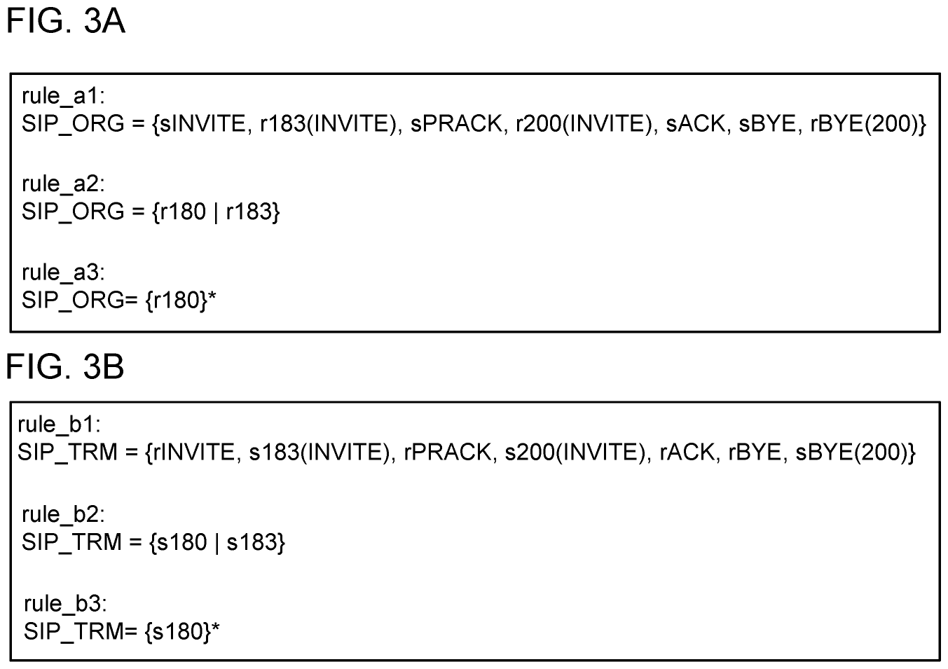

Next, a description is given concerning the sequence pattern template 111 exemplifying a specific example, making reference to FIGS. 3A and 3B. However, in the description below there is no intention to limit the sequence pattern template 111 to the first rule shown as an example below. The sequence pattern template 111 may clearly be also be configured by a combination of rules (first rules) as shown in the example below.

It is to be noted that the description below exemplifies a case where the signal data is signal data corresponding to a voice call. In the following description, in the voice call, a terminal on a transmission side is referred to as a transmission side terminal. In the following description, in the voice call, a terminal on a receiving side is referred to as a receiving side terminal. However there is no limitation to a case where the signal data according to the present example embodiment is signal data corresponding to voice data.

For example, the sequence pattern template 111 may also be configured to include a different first rule, in accordance with transmission source of signal data and transmission destination of signal data. In this case, the data analysis part 140 determines first rules, in accordance with transmission source of signal data and transmission destination of signal data.

For example, FIG. 3A illustrates first rules (rule_a1, rule_a2, rule_a3) corresponding to a transmission side terminal (that is, transmission source of signal data). For example, FIG. 3B illustrates second rules (rule_b1, rule_b2, rule_b3) corresponding to a receiving side terminal (that is, transmission destination of signal data).

In a case where signal data obtained by the data collection part 130 is signal data corresponding to the transmission side terminal, the data analysis part 140 applies the first rules (rule_a1, rule_a2, rule_a3) shown in FIG. 3A, to the obtained signal data.

Meanwhile, in a case where signal data obtained by the data collection part 130 is signal data corresponding to the receiving side terminal, the data analysis part 140 applies the first rules (rule_b1, rule_b2, rule_b3) shown in FIG. 3B, to the obtained signal data.

The sequence pattern template 111 may also be configured to include the order in which signal sequence transmission is performed, or the order in which signal sequence reception is performed. In this case, the data analysis part 140 specifies a signal sequence that satisfies the order defined for a first rule, among signal data obtained by the data collection part 130.

The first rule_a1 is a rule indicating a signal sequence in the order of “sINVITE”, “r183 (INVITE)”, “sPRACK”, “r200 (INVITE)”, “sACK”, “sBYE”, “rBYE (200)”, with regard to the transmission side terminal. Meanwhile, the first rule_b1 is a rule indicating a signal sequence in the order of “rINVITE”, “s183 (INVITE)”,“rPRACK”, “s200 (INVITE)”, “rACK”, “rBYE”, “sBYE (200)”, with regard to the receiving side terminal.

For example the data analysis part 140 applies the first rule rule_a1 to signal data corresponding to the transmission side terminal. In this case, the data analysis part 140 determines whether or not the signal sequence included in the signal data satisfies the order shown in the first rule rule_a1.

Similarly, the data analysis part 140 applies the first rule rule_b1 to signal data corresponding to the receiving side terminal. In this case, the data analysis part 140 determines whether or not the signal sequence included in the signal data satisfies the order shown in the first rule rule_b1.

The sequence pattern template 111 may be also be configured to include an OR condition as a first rule.

For example, the first rule rule_a2 shown in FIG. 3A is a rule indicating, with regard to a transmission side terminal, that a signal sequence may include a signal corresponding to either of “r180” or “r183”. Similarly, the first rule rule_b2 shown in FIG. 3B is a rule indicating, with regard to a receiving side terminal, that a signal sequence may correspond to either of “s180” or “s183”.

For example, the data analysis part 140 applies the first rules rule_a1 and rule_a2, with regard to signal data corresponding to the transmission side terminal. In this case the data analysis part 140 permits “r183 (INVITE)” or “r180 (INVITE)”, among rule_a1.

Similarly, the data analysis part 140 applies the first rules rule_b1 and rule_b2, with regard to signal data corresponding to the receiving side terminal. In this case the data analysis part 140 permits “s183 (INVITE)” or “s180 (INVITE)”, among rule_b1.

The sequence pattern template 111 may also include a regular expression as a first rule.

For example, the first rule rule_a3 shown in FIG. 3A is a rule indicating, with regard to the transmission side terminal, that a signal sequence may repeat a signal corresponding to “r180”. Similarly, the first rule rule_b3 shown in FIG. 3B is a rule indicating, with regard to the receiving side terminal, that signal data may repeat a signal sequence corresponding to “s180”.

For example, the data analysis part 140 applies the first rules rule_a2 and rule_a2, with regard to signal data corresponding to the transmission side terminal. In this case the data analysis part 140 permits the signal data to repeat a signal sequence corresponding to “r180”, or a signal sequence corresponding to “r183”.

Similarly, the data analysis part 140 applies the first rules rule_b2 and rule_b3, with regard to signal data corresponding to the receiving side terminal. In this case the data analysis part 140 permits the signal data to repeat a signal sequence corresponding to “s180”, or a signal sequence corresponding to “s183”.

The data processing part 150 processes (edits) the signal data obtained by the data collection part 130, based on the processing method determined by the data analysis part 140. The data processing part 150 creates test data from the signal data obtained by the data collection part 130.

Specifically, the data processing part 150 uses a derived template pattern to process the signal data and create the processed data (test data).

The scenario creation part 160 creates a test scenario, based on test data created by the data processing part 150 and the processing method determined by the data analysis part 140.

The template management part 120, the data collection part 130, the data analysis part 140, the data processing part 150, and the scenario creation part 160 may be realized as a program executed by a CPU (not illustrated) provided in the data creation apparatus 100. The template management part 120, the data collection part 130, the data analysis part 140, the data processing part 150, and the scenario creation part 160 may also be respectively realized using different hardware, details of which are not of concern.

Next, a detailed description is given concerning operations of the data creation apparatus 100.

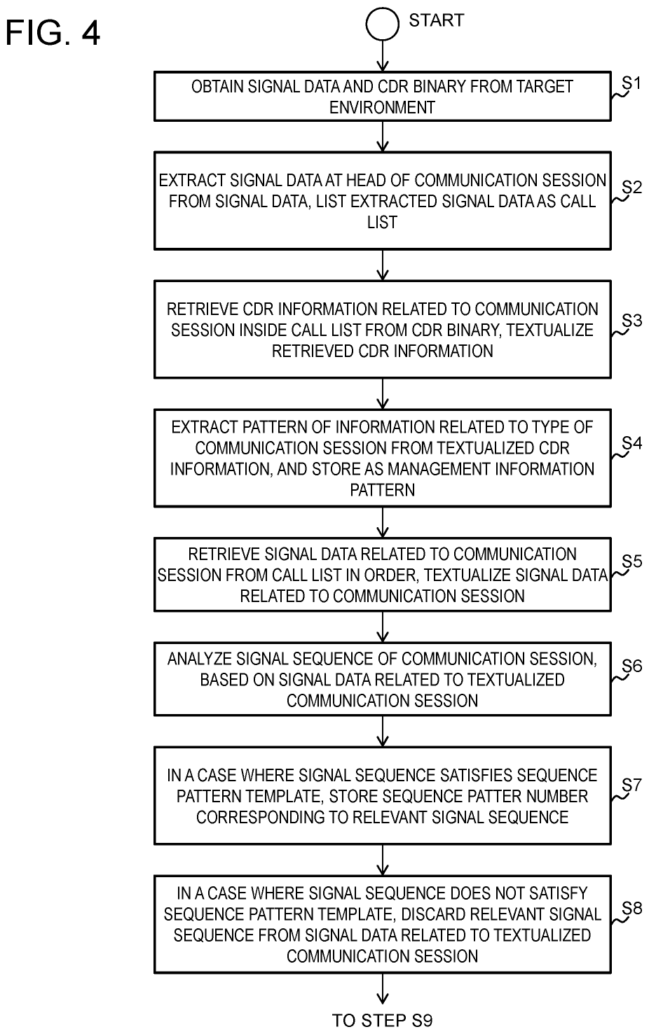

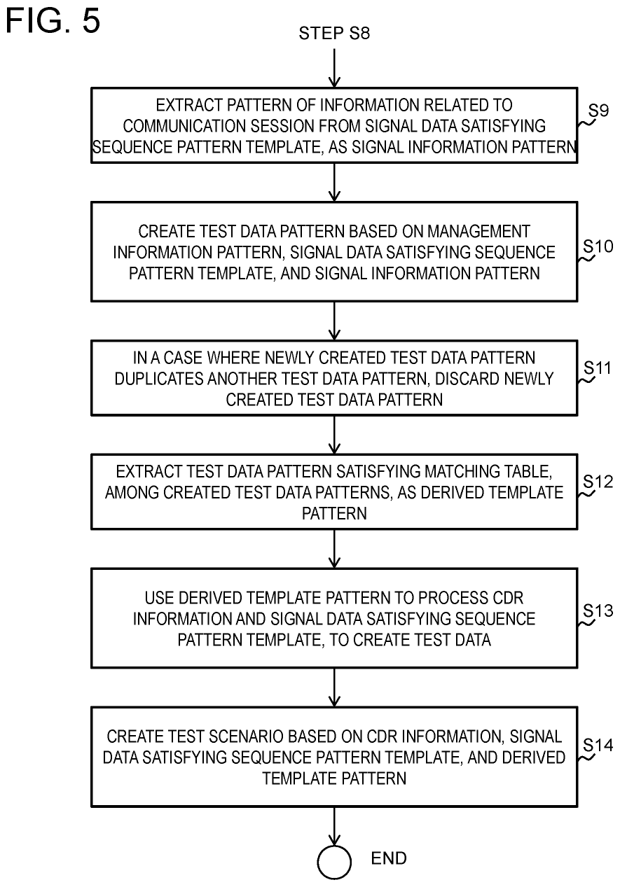

FIG. 4 and FIG. 5 are flowcharts showing an example of operations of the data creation apparatus 100. First, a detailed description is given concerning operations of the data creation apparatus 100, making reference to FIG. 4.

In step S1, the data collection part 130 obtains signal data and CDR binary from a target communication environment 200. For example, in a case where the signal data is signal data corresponding to a voice call, the CDR binary may be configured to include information related to call time, outgoing and incoming number or the like.

In step S2, the data analysis part 140 extracts signal data at the head of a communication session from the signal data, and lists the extracted signals as a Call list.

In step S3, the data analysis part 140 retrieves CDR information related to a communication session in the Call list, from the CDR binary, and textualizes the retrieved CDR information.

In step S4, the data analysis part 140 extracts a pattern of information related to type of communication session from the textualized CDR information, and stores it as a management information pattern. The management information pattern may include, for example, type of communication service or the like.

In step S5, the data analysis part 140 retrieves signal data related to the communication session, in order, from the Call list, and textualizes the signal data related to the communication session. For example, the data analysis part 140 may extract signal data related to the communication session based on information included in a signal at the head of the communication session. For example, information included in the signal at the head of the communication session may include a SIP Call-ID (Identifier), an INAP correlation ID or the like.

In step S6, the data analysis part 140 analyses a signal sequence of the communication session based on signal data related to the textualized communication session.

In a case where the signal sequence of the communication session satisfies the sequence pattern template 111, the data analysis part 140 stores a sequence pattern number corresponding to the relevant signal sequence (step S7).

In a case where the first rule includes a regular expression, an OR condition, or the like, the data analysis part 140 may determine whether or not a signal sequence of a communication session satisfies the prescribed regular expression, the OR condition or the like. In this case, the data analysis part 140 stores a sequence pattern number corresponding to a signal sequence that satisfies the prescribed regular expression, the OR condition or the like.

Meanwhile, in a case where the signal sequence of the communication session does not satisfy the sequence pattern template 111, the data analysis part 140 discards the relevant signal sequence from signal data related to the textualized communication session (step S8).

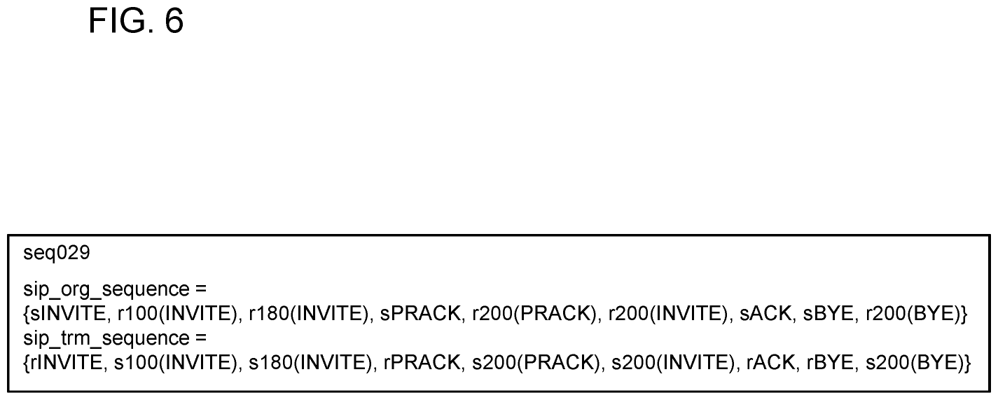

Here, referring to FIGS. 3A, 3B and FIG. 6, an example is shown of a process of applying the sequence pattern template 111 to the signal sequence of the communication session. FIG. 6 shows a textualized signal sequence corresponding to sequence pattern number “seq029”. As shown in FIG. 6, sip_org_sequence indicates a signal sequence of a communication session corresponding to a transmission side terminal. However, the sip_trm_sequence shown in FIG. 6 indicates a signal sequence of a communication session corresponding to a receiving side terminal.

The data analysis part 140 applies rule_a1 and rule_a2 shown in FIG. 3A to sip_org_sequence. The data analysis part 140 determines that sip_org_sequence satisfies rule_a1 and rule_a2.

The data analysis part 140 applies rule_b1 and rule_b2 shown in FIG. 3B to sip_trm_sequence. In this case, the data analysis part 140 determines that sip_trm_sequence satisfies rule_b1, rule_b2.

Therefore, since the signal sequence of the communication session satisfies the sequence pattern template 111, the data analysis part 140 stores a sequence pattern number “seq029” corresponding to the relevant signal sequence.

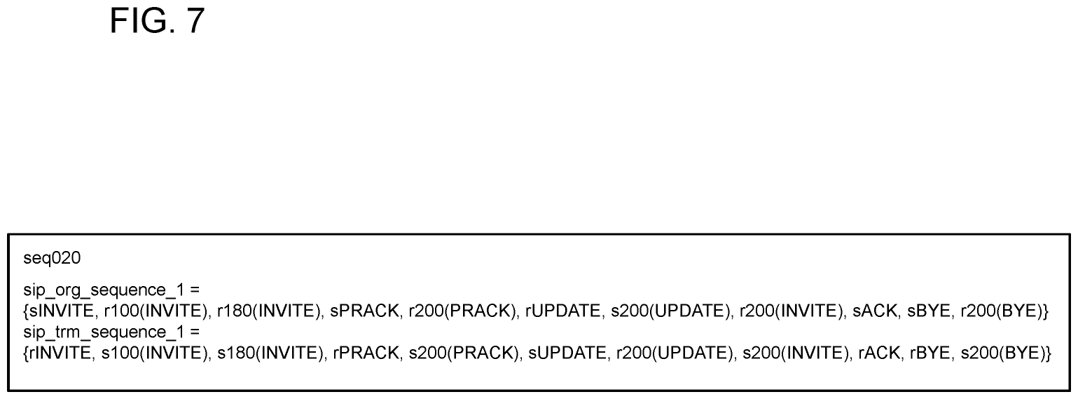

Next, referring to FIGS. 3A, 3B and FIG. 7, an example is shown of another process of applying the sequence pattern template 111 to the signal sequence of the communication session. FIG. 7 shows a textualized signal sequence corresponding to sequence pattern number “seq020”. As shown in FIG. 7, sip_org_sequence_1 indicates a signal sequence of a communication session corresponding to a transmission side terminal. Meanwhile, sip_trm_sequence_1 shown in FIG. 7 indicates a signal sequence of a communication session corresponding to a receiving side terminal.

The data analysis part 140 applies rule_a1 and rule_a2 shown in FIG. 3A to sip_org_sequence_1. In this case, the data analysis part 140 determines that sip_org_sequence_1 satisfies rule_a1 and rule_a2. Here, among sip_org_sequence_1, “rUPDATE”, “s200 (UPDATE)” do not satisfy rule_a1 and rule_a2. Therefore, the data analysis part 140 discards “rUPDATE” and “s200 (UPDATE)” from sip_org_sequence_1.

The data analysis part 140 applies rule_b1 and rule_b2 shown in FIG. 3B to sip_trm_sequence_1 shown in FIG. 7. In this case, the data analysis part 140 determines that sip_trm_sequence_1 shown in FIG. 7 satisfies rule_b1 and rule_b2 shown in FIG. 3B. Here, among sip_trm_sequence_1, “sUPDATE” and “r200 (UPDATE)” do not satisfy rule_b1 and rule_b2. Therefore, the data analysis part 140 removes “sUPDATE” and “r200 (UPDATE)” from sip_trm_sequence_1.

The data analysis part 140 stores a sequence pattern number “seq020”.

It is to be noted that in the following description, for convenience “signal data satisfying the sequence pattern template 111” indicates signal data related to a textualized communication session satisfying a sequence pattern template 111.

In a case where the signal sequence of the communication session does not satisfy the sequence pattern template 111, the signal sequence may be an abnormal sequence. Here, an abnormal sequence includes a non-completed signal sequence. A non-completed signal sequence indicates a signal where communication has not been normally completed. For example, a non-completed signal sequence includes a no-response signal sequence.

An abnormal sequence is not appropriate as test data. Therefore, the data creation apparatus 100 discards the abnormal sequence from signal data obtained from the target communication environment 200. As a result, the data creation apparatus 100 contributes to avoiding useless testing. Furthermore, the data creation apparatus 100 contributes to reducing testing time, by avoiding useless testing.

In step S9, the data analysis part 140 extracts a pattern of information related to the communication session from signal data satisfying the sequence pattern template 111, as a signal information pattern. Specifically, the data analysis part 140 extracts a signal information pattern from textualized signal data satisfying the sequence pattern template 111. Specifically, the data analysis part 140 extracts an option parameter pattern of an “ISUP IAM (Initial Address Message)” signal from textualized signal data satisfying the sequence pattern template 111, as a signal information pattern.

In step S10, the data processing part 150 creates a test data pattern, based on a management information pattern, signal data satisfying the sequence pattern template 111, and a signal information pattern.

In step S11, in a case where a newly created test data pattern duplicates another test data pattern, the data processing part 150 discards the newly created test data pattern.

The data creation apparatus 100 contributes to reducing testing time, by discarding the duplicated test data pattern.

In step S12, the data processing part 150 extracts a test data pattern satisfying a matching table 112, among the created test data patterns, as a derived template pattern.

In step S13, the data processing part 150 uses the derived template pattern to process CDR information and signal data satisfying the sequence pattern template 111, to create test data. Specifically, the data processing part 150 uses the derived template pattern to process textualized CDR information, and signal data satisfying the sequence pattern template 111, to create test data.

In step S14, the scenario creation part 160 creates a test scenario, based on CDR information, signal data satisfying the sequence pattern template 111, and the derived template pattern. Specifically, the scenario creation part 160 creates a test scenario based on textualized CDR information, signal data satisfying the sequence pattern template 111, and the derived template pattern.

### MODIFIED EXAMPLE 1

As a modified example 1 of the data creation apparatus 100 according to the present example embodiment, the data creation apparatus 100 may obtain an application log including information that can specify communication content, from the target communication environment 200, as management information, instead of a CDR binary.

As described above, the data creation apparatus 100 according to the present example embodiment obtains signal data flowing in the target communication environment 200. The data creation apparatus 100 according to the present example embodiment uses a rule created by a user to process signal data that has been obtained. Therefore, the data creation apparatus 100 according to the present example embodiment contributes to facilitating the creation of data corresponding to a user's intent from a signal flowing in an arbitrary communication environment (target communication environment 200).

The data creation apparatus 100 according to the present example embodiment, for convenience, may change an arbitrary rule (first rules and second rules). The data creation apparatus 100 according to the present example embodiment uses the changed rule (first rules and second rules) to create processed data satisfying the rule, from the signal data flowing in the communication environment. Therefore, the data creation apparatus 100 according to the present example embodiment contributes to facilitating creation of data needed by a tester, as required.

The data creation apparatus 100 according to the present example embodiment can take signal data obtained from the target communication environment 200 as a basic sequence, by having a configuration in which the sequence pattern template 111 includes a regular expression, OR condition, or the like. Accordingly, the data creation apparatus 100 can easily discard unnecessary signal data. Therefore, the data creation apparatus 100 according to the present example embodiment contributes to reducing test time, improving test stability, and predicting test time.

The data creation apparatus 100 according to the present example embodiment uses the sequence pattern template 111 and CDR to create test data. Therefore, the data creation apparatus 100 according to the present example embodiment contributes to facilitating specifying type of signal sequence included in the created test data.

The data creation apparatus 100 according to the present example embodiment uses the sequence pattern template 111 and CDR to create a test scenario. Therefore, the data creation apparatus 100 according to the present example embodiment contributes to facilitating specifying the type of signal sequence included in the created test scenario.

Therefore, the data creation apparatus 100 according to the present example embodiment contributes to integrating test items, limiting test target range, and aggregating test results.

Some or all of the abovementioned example embodiments may also be described as in the following modes, but there is no limitation to the following.

(Mode 1) As in the data creation apparatus according to the first aspect described above.

(Mode 2) The data creation apparatus preferably according to mode 1, comprising a template management part that obtains one or more of the first rules, and stores the obtained first rule(s) in the storage part as the template.

(Mode 3) The data creation apparatus preferably according to mode 2, wherein the template management part obtains the first rule(s), based on a user operation.

(Mode 4) The data creation apparatus preferably according to mode 2 or 3, wherein the template management part obtains a file describing the first rule(s), and stores the file in the storage part as the template.

(Mode 5) The data creation apparatus preferably according to any one of modes 1 to 4, comprising a scenario creation part that creates a test scenario based on the processed data and the processing method.

(Mode 6) The data creation apparatus preferably according to any one of modes 1 to 5, wherein the data collection part obtains the signal data that includes a signal sequence related to a communication session and management information specifying communication content, from the target communication environment.

(Mode 7) The data creation apparatus preferably according to mode 6, wherein the data analysis part discards the signal sequence that does not satisfy the first rule(s), from the signal data.

(Mode 8) The data creation apparatus according to mode 6 or 7, wherein the data analysis part extracts the signal sequence that satisfies the first rule(s) from the signal data, creates a first data pattern based on the extracted signal sequence, and determines the processing method using the first data pattern.

(Mode 9) The data creation apparatus preferably according to mode 8, wherein the storage part further stores a second rule(s) that differs from the first rule(s), the data analysis part applies the second rule(s) to the first data pattern and creates the second data pattern, and the data processing part uses the second data pattern to process the signal data and create the processed data.

(Mode 10) The data creation apparatus preferably according to mode 8 or 9, wherein the data analysis part extracts the signal sequence that satisfies the first rule(s) from the signal data, extracts a third data pattern from the extracted signal sequence, and uses the third data pattern to create the first data pattern.

(Mode 11) The data creation apparatus preferably according to mode 10, wherein the data analysis part creates the fourth data pattern related to type of communication session, based on the management information, and creates the first data pattern, based on the signal sequence that satisfies the first rule(s), the third data pattern and the fourth data pattern.

(Mode 12) As in the testing system according to the second aspect described above.

(Mode 13) The testing system preferably according to mode 12, comprising a template management part that obtains one or more of the first rules, and stores the obtained first rule(s) in the storage part as the template.

(Mode 14) The testing system preferably according to mode 12 or 13, comprising a scenario creation part that creates a test scenario based on the processed data and the processing method.

(Mode 15) The testing system preferably according to any one of modes 12 to 14, wherein the data collection part obtains the signal data that includes a signal sequence related to a communication session, and management information specifying communication content, from the target communication environment.

(Mode 16) As in the data creation method according to the third aspect described above.

(Mode 17) The data creation method preferably according to mode 16, comprising obtaining one or more of the first rules, and storing the obtained first rule(s) as the template.

(Mode 18) The data creation method preferably according to mode 16 or 17, comprising creating a test scenario based on the processed data and the processing method.

(Mode 19) The data creation method preferably according to any one of modes 16 to 18, comprising obtaining the signal data that includes a signal sequence related to a communication session, and management information specifying communication content, from the target communication environment.

(Mode 20) As in a program according to the fourth aspect described above.

(Mode 21) The program preferably according to mode 20, comprising obtaining one or more of the first rules, and storing the obtained first rule(s) as the template.

(Mode 22) The program preferably according to mode 20 or 21, comprising causing a computer to execute creation of a test scenario based on the processed data and the processing method.

(Mode 23) The program preferably according to any one of modes 20 to 22, comprising causing a computer to execute obtaining the signal data that includes a signal sequence related to a communication session, and management information specifying communication content, from the target communication environment.

It is to be noted that the modes illustrated in the abovementioned modes 12, 16 and 20 may be extended with regard to modes 3, 4, and 7 to 11, similar to the mode illustrated in mode 1.

It is to be noted that the various disclosures of the abovementioned Patent Literature are incorporated herein by reference thereto. Modifications and adjustments of example embodiments are possible within the bounds of the entire disclosure (including the scope of the claims) of the present invention, and also based on fundamental technological concepts thereof. Various combinations and selections (including partial removals) of various disclosed elements (including respective elements of the respective claims, respective elements of the respective example embodiments, respective elements of the respective drawings and the like) are possible within the scope of the disclosure of the present invention. That is, the present invention clearly includes every type of transformation and modification that a person skilled in the art can realize according to the entire disclosure including the scope of the claims and to technological concepts thereof. In particular, with regard to numerical ranges described in the present specification, arbitrary numerical values and small ranges included in the relevant ranges should be interpreted to be specifically described even where there is no particular description thereof. In the present invention, in a case where an algorithm, software, a flowchart or an automated process step is indicated, it is self-evident that a computer is used, and it is self-evident that a processor, memory and storage apparatus are installed in the computer. Therefore, even in a case where an explicit specification thereof is absent, it is understood that these elements are clearly described in the present application.

### REFERENCE SIGNS LIST

100, 1000 data creation apparatus
110, 1010 storage part
111 sequence pattern template
112 matching table
120 template management part
130, 1020 data collection part
140, 1030 data analysis part
150, 1040 data processing part
160 scenario creation part
200 target communication environment
1011 first rule
1012 template

What is claimed is:

1. A data creation apparatus, comprising:
a storage part that stores one or more first rules as a template;
a data collection part that obtains signal data from a target communication environment;
a data analysis part that uses the template to determine a processing method for the signal data; and
a data processing part that processes the signal data based on the processing method, to create processed data.

2. The data creation apparatus according to claim 1, comprising a template management part that obtains one or more of the first rules, and stores the obtained first rule(s) in the storage part as the template.

3. The data creation apparatus according to claim 2, wherein the template management part obtains the first rule(s), based on a user operation.

4. The data creation apparatus according to claim 2, wherein the template management part obtains a file describing the first rule(s), and stores the file in the storage part as the template.

5. The data creation apparatus according to claim 1, comprising a scenario creation part that creates a test scenario based on the processed data and the processing method.

6. The data creation apparatus according to claim 1, wherein the data collection part obtains the signal data that includes a signal sequence related to a communication session and management information specifying communication content, from the target communication environment.

7. The data creation apparatus according to claim 6, wherein the data analysis part discards the signal sequence that does not satisfy the first rule(s), from the signal data.

8. The data creation apparatus according to claim 6, wherein the data analysis part extracts the signal sequence that satisfies the first rule(s), from the signal data, creates a first data pattern based on the extracted signal sequence, and determines the processing method using the first data pattern.

9. The data creation apparatus according to claim 8, wherein the storage part further stores a second rule(s) that differs from the first rule(s), the data analysis part applies the second rule(s) to the first data pattern and creates the second data pattern, and the data processing part uses the second data pattern to process the signal data.

10. The data creation apparatus according to claim 8, wherein the data analysis part extracts the signal sequence that satisfies the first rule(s), from the signal data, extracts a third data pattern from the extracted signal sequence, and uses the third data pattern to create the first data pattern.

11. The data creation apparatus according to claim 10, wherein the data analysis part creates the fourth data pattern related to type of communication session, based on the management information, and creates the first data pattern, based on the signal sequence that satisfies the first rule(s), the third data pattern and the fourth data pattern.

12-15. (canceled)

16. A data creation method, comprising:
storing one or more first rules as a template,
obtaining signal data from a target communication environment;
determining a processing method for the signal data by using the template; and
processing the signal data based on the processing method to create processed data.

17. The data creation method according to claim 16, comprising:
obtaining one or more of the first rules, and
storing the obtained first rule(s) as the template.

18. The data creation method according to claim 16, comprising:
creating a test scenario based on the processed data and the processing method.

19. The data creation method according to claim 16, comprising:
obtaining the signal data that includes a signal sequence related to a communication session, and management information specifying communication content, from the target communication environment.

20. A non-transient computer-readable storage medium storing a program that causes a computer controlling a data creation apparatus to execute processing, comprising:
storing one or more first rules as a template;
obtaining signal data from a target communication environment;
determining a processing method for the signal data by using the template; and
processing the signal data based on the processing method, to create processed data.

21. The non-transient computer-readable storage medium storing the program according to claim 20, the processing comprising:
obtaining one or more of the first rules, and
storing the obtained first rule as the template.

22. The non-transient computer-readable storage medium storing the program according to claim 20, the processing comprising:
creating a test scenario based on the processed data and the processing method.

23. The non-transient computer-readable storage medium storing the program according to claim 20, the processing comprising:
obtaining the signal data that includes a signal sequence related to a communication session, and management information specifying communication content, from the target communication environment.

24. The non-transient computer-readable storage medium storing the program according to claim 23, the processing comprising:
extracting the signal sequence that satisfies the first rule, from the signal data,
creating a first data pattern based on the extracted signal sequence, and
determining the processing method using the first data pattern.
